(19) United States
(12) Patent Application Publication
(10) Pub. No.: US 2024/0326657 A1
(43) Pub. Date: Oct. 3, 2024

(54) SYSTEM, CONTROL METHOD, AND COMPUTER READABLE STORAGE MEDIUM

(71) Applicant: HONDA MOTOR CO.,LTD., Tokyo (JP)

(72) Inventors: Satoshi MATSUI, Saitama (JP); Shinya WATANABE, Saitama (JP); Kosuke IHARA, Saitama (JP); Norimasa KAWAGOE, Saitama (JP)

(21) Appl. No.: 18/614,726

(22) Filed: Mar. 24, 2024

(30) Foreign Application Priority Data
Mar. 28, 2023 (JP) 2023-052469

(51) Int. Cl. B60L 58/40; H01M 8/04313; H01M 8/04858

(52) U.S. Cl. CPC B60L 58/40; H01M 8/04313; H01M 8/04925; H01M 2250/20

(57) ABSTRACT

A system for controlling power source including a fuel cell and a battery provided on a vehicle, the system comprises a decision unit that decides a control parameter for power generation amount of the fuel cell based on whether the vehicle is a vehicle that mainly travels on a highway or a vehicle that mainly travels on an ordinary road. A control method for controlling power source including a fuel cell and a battery provided on a vehicle comprises deciding a control parameter for power generation amount of the fuel cell based on whether the vehicle is a vehicle that mainly travels on a highway or a vehicle that mainly travels on an ordinary road.

The contents of the following Japanese patent application(s) are incorporated herein by reference:
NO. 2023-052469 filed in JP on Mar. 28, 2023.

### BACKGROUND

### 1. Technical Field

The present invention relates to a system, a control method, and a computer readable storage medium.

### 2. Related Art

In recent years, research and development related to improvement in fuel economy, which contributes to optimization of energy usage, have been conducted so as to ensure access by more people to sustainable and advanced energy that is convenient and reliable. In below patent documents, techniques for performing decision related to failure or abnormalities in vehicles by using information collected from the vehicles are described.

### RELATED ART DOCUMENTS

### Patent Documents

Patent Document 1: Japanese Patent Application Publication No. 2020-119236
Patent Document 2: Japanese Patent No. 4369825
Patent Document 3: Japanese Patent No. 6135545
Patent Document 4: Japanese Patent Application Publication No. 2009-198393
Patent Document 5: Japanese Patent Application Publication No. 2009-294004
Patent Document 6: International Publication No. 2021/111726 specification

### BRIEF DESCRIPTION OF THE DRAWINGS

FIG. 1 conceptually illustrates a utilization form of a control system 190 in an embodiment.

FIG. 2 illustrates an example of a configuration of a moving body system 100.

FIG. 3 illustrates an example of a configuration of a system 180.

FIG. 4 illustrates a calculation method for calculating a power generation amount of a fuel cell 270 by a control device 260.

FIG. 5 is a graph that represents output request value-power generation amount set value table 400 as a function of an output request value.

FIG. 6 describes a graph that represents SOC-power generation compensation amount table 430 as a function of SOC.

FIG. 7 schematically illustrates temporal change in the power generation amount of a fuel cell when a base power generation amount set value is set to be low.

FIG. 8 illustrates the power generation amount of a fuel cell 270 when a base power generation amount set value is set to be relatively high.

FIG. 9 is an example of a graph that represents the SOC-power generation compensation amount table 430 as a function of SOC.

FIG. 10 is an example of the power generation amount of a fuel cell 270 when SOC-power generation compensation amount table 430 illustrated in FIG. 9 is used.

FIG. 11 illustrates a data structure of information indicating a driving history of a moving body 10, which is stored in a storage unit 390 of the system 180.

FIG. 12 illustrates a data structure of control parameter information for each group stored in the storage unit 390 of the system 180.

FIG. 13 illustrates a control sequence in a case where the control parameter of the fuel cell 270 is updated by reprogramming the control device 260.

FIG. 14 illustrates a form in which the control parameter of the control device 260 is updated by providing the control device 260 with instructions on the control parameter.

FIG. 15 illustrates an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

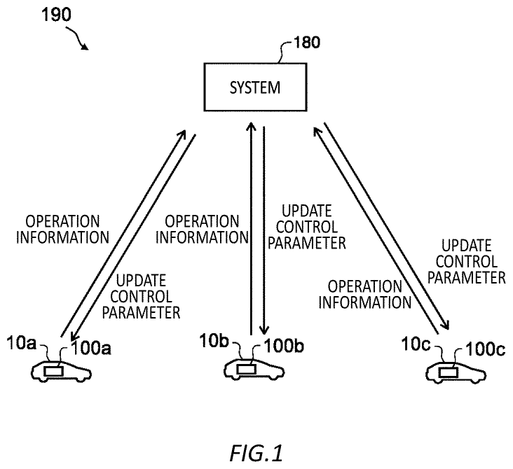

FIG. 1 conceptually illustrates a utilization form of a control system 190 in an embodiment. The control system 190 includes a system 180, and a plurality of moving bodies including a moving body 10a, a moving body 10b, and a moving body 10c.

In the present embodiment, the moving body 10a, the moving body 10b, and the moving body 10c are vehicles each comprising a fuel cell. The moving body 10a, the moving body 10b, and the moving body 10c comprise a moving body system 100a, a moving body system 100b, and a moving body system 100c, respectively. Each of the moving body system 100a, the moving body system 100b, and the moving body system 100c is capable of communicating with the system 180 via a mobile communication network. In the present embodiment, the plurality of moving bodies including the moving body 10a, the moving body 10b, and the moving body 10c may be collectively referred to as the “moving body 10”, and the plurality of moving body systems including the moving body system 100a, the moving body system 100b, and the moving body system 100c may be collectively referred to as the “moving body system 100”.

The moving body system 100 includes a fuel cell and a battery as a power source. The moving body 10 travels with electrical power supplied from the fuel cell and the battery. The moving body system 100 periodically transmits driving information of the moving body 10 at a plurality of time to the system 180. The driving information includes the location of the moving body 10, the speed of the moving body 10, the output current and charge percentage (SOC) of the fuel cell provided on the moving body system 100, and manipulation information such as information indicating the opening degree of the accelerator provided on the moving body 10.

The system 180 accumulates, as the driving history, the driving information that is periodically transmitted from the moving body system 100. The system 180 separates the moving bodies 10 into a plurality of groups according to the travel modes of the moving bodies 10, based on the driving history. For example, the moving body system 100 separates the moving bodies 10 into a group of those that mainly travel on a highway and a group of those that mainly travels on an ordinary road, based on the locational histories of the moving bodies 10 included in the driving history and map information. The system 180 sets a control parameter for the fuel cell suitable for each group, based on the driving history of the moving bodies 10 separated into each group.

The system 180 instructs the moving body 10 to control the fuel cell with the control parameter set for the group to which the moving body 10 belongs. For example, the system 180 transmits, to the moving body 10 which belongs to the group of those that mainly travel on a highway, an update program from the control parameter set for that group, and instructs the moving body 10 to reprogram, with the update program, the control device for controlling the fuel cell. In addition, the system 180 transmits control parameters for a plurality of groups to the moving body 10 in advance, and instructs the moving body 10 which belongs to the group of those that mainly travels on a highway to control the control device of the fuel cell according to the control parameter set for that group. In this manner, the control parameter of the control device that controls the fuel cell of the moving body 10 can be updated to a control parameter suitable for the group to which the moving body 10 belongs. In this manner, the fuel cell can be controlled with an appropriate control parameter according to the travel mode of the moving body 10. Accordingly, it can be expected that the fuel economy of the fuel cell will be improved, and degradation will be reduced.

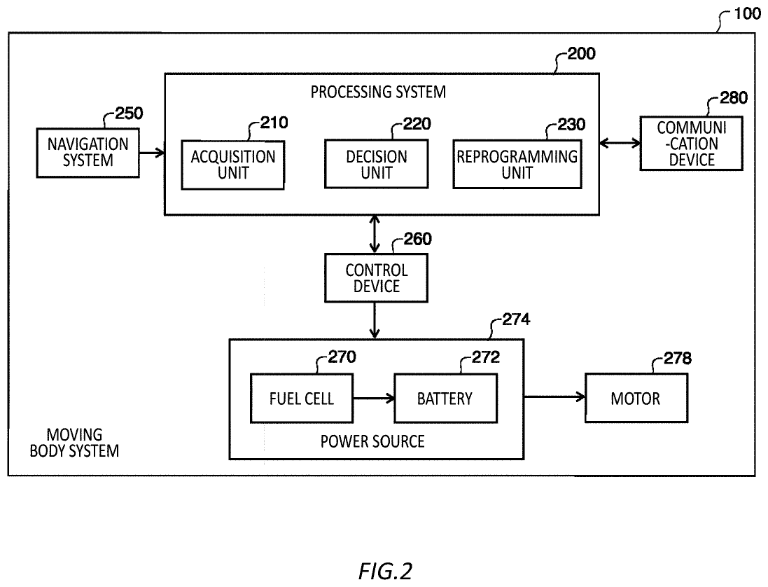

FIG. 2 illustrates an example of a configuration of a moving body system 100. The moving body system 100 comprises a processing system 200, a communication device 280, a navigation system 250, a control device 260, a power source 274, and a motor 278. The control device 260 controls the power source 274. The processing system 200 and the control device 260 may be achieved by one or more computers.

The motor 278 operates with electrical power supplied from the power source 274 to generate driving force for driving the wheels provided on the moving body 10. The power source 274 comprises a fuel cell 270 and a battery 272.

The control device 260 controls the fuel cell 270 and the battery 272. The control device 260 controls the fuel cell 270 according to a predetermined control parameter for the fuel cell. The control device 260 controls the battery 272 according to a predetermined control parameter for the battery. The control device 260 may be achieved by one or more computers. In the control device 260, a control parameter for the fuel cell 270 and a control parameter for the battery 272 are set in a control program for controlling the fuel cell 270 and the battery 272. In this manner, the control device 260 controls the fuel cell 270 and the battery 272 according to control parameters set in the control program. The control device 260 may be achieved by one or more computers that control the fuel cell 270 and one or more computers that control the battery 272.

The communication device 280 performs communication through a mobile communication network. The communication device 280 is responsible for communication between the system 180 and the moving body system 100. The navigation system 250 provides navigation information to a user of the moving body 10. The navigation system 250 outputs, to processing system 200, information indicating the current location of the moving body 10, scheduled traveling route of the moving body 10. The communication device 280 receives information related to the control parameter transmitted from the system 180. The information related to the control parameter may be an update program to be used for reprogramming, for example, or may be identification information of one control parameter among a plurality of predetermined control parameters.

The processing system 200 comprises an acquisition unit 210, a decision unit 220, and a reprogramming unit 230. The acquisition unit 210 acquires operation information of the fuel cell 270 and operation information of the battery 272 from the control device 260. The operation information the fuel cell 270 includes information indicating the power generation amount, output power, output current, output voltage of the fuel cell 270, or the like. The operation information of the battery 272 includes information indicating SOC of the battery 272 or the like. The acquisition unit 210 acquires manipulation information for manipulating the traveling of the moving body 10

For example, the acquisition unit 210 acquires manipulation information of an accelerator pedal. The manipulation information of the accelerator pedal includes information indicating accelerator opening degree, for example. The acquisition unit 210 may acquire manipulation information of various types of other manipulating members such as a brake pedal. The acquisition unit 210 transmits, to the system 180 through the communication device 280 information indicating the current location of the moving body 10 output from the navigation system 250 and information indicating the scheduled traveling route of the moving body 10.

The reprogramming unit 230 reprograms the control device 260 through the update program received from the system 180. The decision unit 220 decides which control parameter among the plurality of control parameters to use to control the fuel cell 270 and the battery 272, based on the identification information the control parameter received from the system 180. The control device 260 controls the fuel cell 270 and the battery 272 according to the control parameter decided by the decision unit 220, among the plurality of control parameters stored in the control device 260.

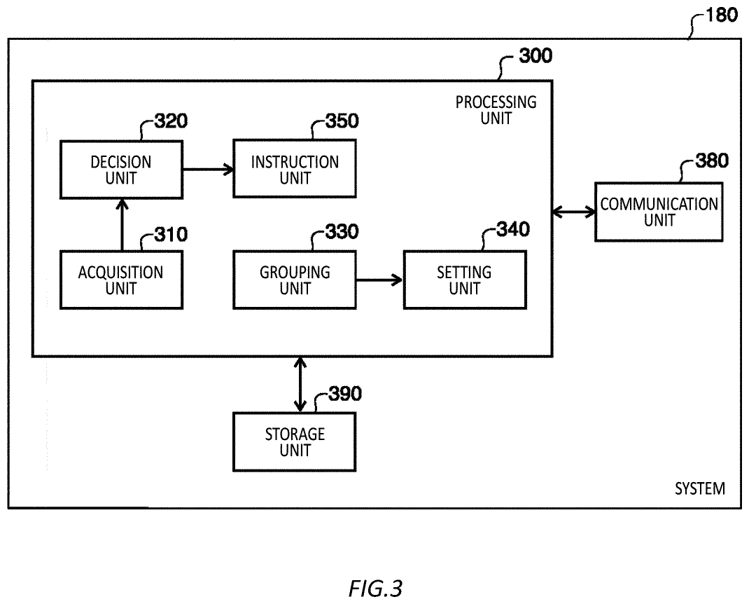

FIG. 3 illustrates an example of a configuration of the system 180. The system 180 functions as a system for controlling the power source 274 including the fuel cell 270 and the battery 272 provided on the moving body 10.

The system 180 comprises a processing unit 300, a communication unit 380 and a storage unit 390. The system 180 may be achieved by one or more computers.

The communication unit 380 is responsible for communication through a mobile communication network with the moving body 10. The storage unit 390 stores information required for operation of the system 180. The storage unit 390 is configured to include a non-volatile storage medium.

The processing unit 300 comprises an acquisition unit 310, a decision unit 320, a grouping unit 330, a setting unit 340, and an instruction unit 350. The decision unit 220 decides a control parameter for power generation amount of the fuel cell 270 based on whether the moving body 10 is a moving body 10 that mainly travels on a highway or a moving body 10 that mainly travels on an ordinary road. For example, the acquisition unit 210 acquires information indicating the driving history of the moving body 10. The decision unit 220 decides, based on the driving history, whether the moving body 10 is a moving body 10 that mainly travels on a highway or a moving body 10 that mainly travels on an ordinary road.

The control parameter for power generation amount is defined from an output request to the power source 274, and includes a set value that becomes constant with respect to the output request at least within a predetermined range. For example, the control parameter for power generation amount includes a compensation amount for compensating the power generation amount of the fuel cell 270 with respect to the set value to bring the charge percentage of the battery 272 closer to a predetermined target value.

The decision unit 220 may reduce the compensation amount when it is decided that the moving body 10 is a moving body 10 that mainly travels on a highway as compared to when it is decided that the moving body 10 is a moving body 10 that mainly travels on an ordinary road.

The decision unit 220 may increase the set value when it is decided that the moving body 10 is a moving body 10 that mainly travels on a highway as compared to when it is decided that the moving body 10 is a moving body 10 that mainly travels on an ordinary road. The decision unit 220 may reduce the compensation amount and increase the set value when it is decided that the moving body 10 is a moving body 10 that mainly travels on a highway as compared to when it is decided that the moving body 10 is a moving body 10 that mainly travels on an ordinary road.

The decision unit 220 may reduce the set value when it is decided that the moving body 10 is a moving body 10 that mainly travels on an ordinary road as compared to when it is decided that the moving body 10 is a moving body 10 that mainly travels on a highway.

The decision unit 220 may increase the compensation amount when it is decided that the moving body 10 is a moving body 10 that mainly travels on an ordinary road as compared to when it is decided that the moving body 10 is a moving body 10 that mainly travels on a highway. The decision unit 220 may reduce the set value and increase the compensation amount when it is decided that the moving body 10 is a moving body 10 that mainly travels on an ordinary road as compared to when it is decided that the moving body 10 is a moving body 10 that mainly travels on a highway,

The acquisition unit 210 acquires information indicating driving histories of a plurality of moving bodies 10. The grouping unit 330 generates a plurality of groups according to traveling modes of the plurality of moving bodies 10, based on information indicating driving histories of the plurality of moving bodies 10. The setting unit 340 sets, for each of the plurality of groups, the control parameter for the moving bodies 10 that belong to each group, based on information indicating the driving histories of the plurality of moving bodies 10. The decision unit 220 decides which group among the plurality of groups the traveling mode of the moving body 10 belongs to, based on the driving history of the moving body 10, and decides that the control parameter set for the group decided is to be set as the control parameter for the fuel cell 270 included in the power source 274 of the moving body 10.

The instruction unit 350 instructs the moving body 10 to reprogram the control device of the power source 274 provided on the moving body 10 such that the fuel cell 270 is controlled based on the control parameter decided by the decision unit 220. The moving body 10 may store the plurality of control parameters set for the plurality of groups. In this case, the instruction unit 350 may instruct the moving body 10 to control the fuel cell 270 based on the control parameter decided by the decision unit 220

The decision unit 220 may decide the control parameter further based on at least one of a scheduled traveling route of the moving body 10 and current location of the moving body 10.

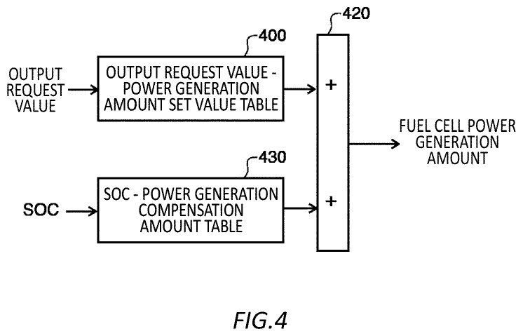

FIG. 4 illustrates a calculation method for calculating a power generation amount of the fuel cell 270 by a control device 260. An output request value to the power source 274 and the SOC of the battery 272 is input to the control device 260. The output request value may be a value decided by considering manipulation amount related to traveling of the moving body 10, such as the accelerator opening degree, for example. The output request value may be a value decided by considering controlled variables related to traveling of the moving body 10, other electrical power demands in the moving body 10.

Output request value-power generation amount set value table 400 is used to convert the output request value to the power source 274 into a power generation amount set value of the fuel cell 270. The control device 260 converts the output request value input thereto into the power generation amount set value by using the output request value-power generation amount set value table 400. The power generation amount set value converted from the output request value is input to an adder 420.

The SOC-power generation compensation amount table 430 is a table used to convert the SOC into a power generation compensation amount for the power generation amount set value. The control device 260 converts the SOC of the battery 272 into the power generation compensation amount by using the SOC-power generation compensation amount table 430. Said power generation compensation amount is input to the adder 420.

The adder 420 outputs an addition result of the power generation amount set value converted from the output request value and the power generation compensation amount obtained from the SOC-power generation compensation amount table 430. The output of the adder 420 is used as a target value for the power generation amount of the fuel cell 270. The final target value for the power generation amount of the fuel cell 270 may be decided further based on information other than the output of the adder 420.

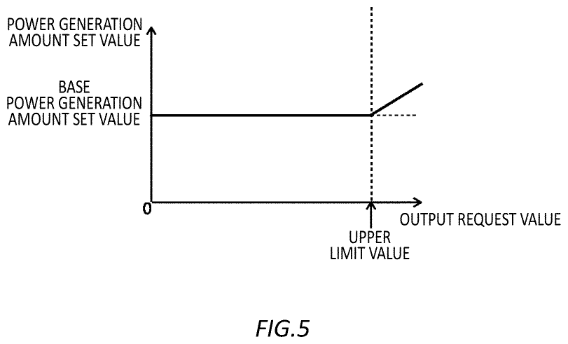

FIG. 5 is a graph that represents output request value-power generation amount set value table 400 as a function of an output request value. The horizontal axis represents the output request value, and the vertical axis represents the power generation amount set value of the fuel cell. When the output request value is equal to or lower than an upper limit value, the power generation amount set value becomes a constant value. In the present embodiment, this constant value is referred to as a “base power generation amount set value”.

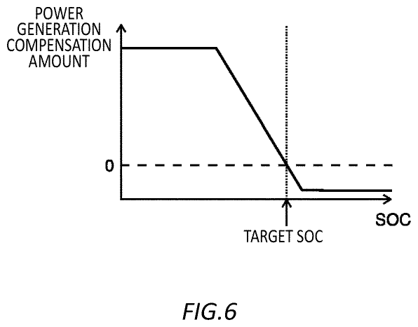

FIG. 6 describes a graph that represents SOC-power generation compensation amount table 430 as a function of SOC. The horizontal axis represents the SOC, and the vertical axis represents the power generation compensation amount for the power generation amount set value.

The feature of the SOC-power generation compensation amount table 430 is characterized by the target SOC and the gradient of graph of the power generation compensation amount with respect to the SOC. The target SOC functions as the target value of SOC of the battery 272. When the SOC of the battery 272 matches with the target SOC, the power generation compensation amount becomes zero. When the SOC of the battery 272 is lower than the target SOC, the power generation compensation amount becomes positive, and when the SOC of the battery 272 is higher than the target SOC, the power generation compensation amount becomes negative. Therefore, the power generation compensation amount with respect to the SOC shows a graph with a negative gradient as a whole.

As described in connection to FIG. 4 and the like, the control device 260 calculates the target value of power generation of the fuel cell 270 by adding the power generation amount set value calculated from the output request value by using the output request value-power generation amount set value table 400 and the power generation compensation amount. In this manner, when the SOC of the battery 272 is lower than the target SOC, the power generation amount of the fuel cell 270 is increased to be higher than the power generation amount set value. On the other hand, when the SOC of the battery 272 is higher than the target SOC, the power generation amount of the fuel cell 270 is reduced to be lower than the power generation amount set value. The SOC of the battery 272 can be controlled to be brought closer to the target SOC.

The absolute value of a gradient of the graph of the power generation compensation amount with respect to the SOC represents time responsiveness of bringing the SOC of the battery 272 closer to the target SOC. That is, the larger the absolute value of the gradient of the graph of the power generation compensation amount with respect to the SOC, the shorter the time it takes for the SOC of the battery 272 to reach the target SOC becomes. The smaller the absolute value of the gradient of the graph of the power generation compensation amount with respect to the SOC, the longer the time it takes for the SOC of the battery 272 to be brought closer to the target SOC becomes.

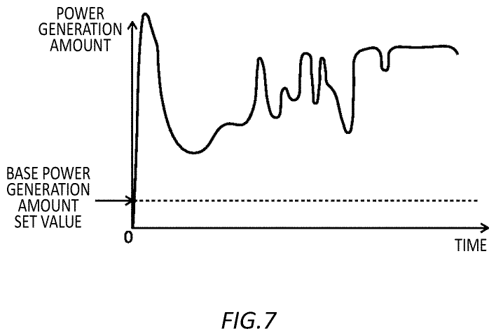

FIG. 7 schematically illustrates temporal change in the power generation amount of a fuel cell when a base power generation amount set value is set to be low. In order to supplement the lack of base power generation amount set value with respect to the output request value to the power source, the output power of the battery is increased. In this manner, the SOC of the battery is largely reduced. As a result, the power generation compensation amount for bringing the SOC of the battery closer to the target SOC is increased. Consequently, the temporal change in the power generation amount of the fuel cell may be largely varied to correspond to the output request value. In this manner, degradation of the fuel cell becomes more likely to advance, and the fuel economy of the fuel cell becomes more likely to deteriorate.

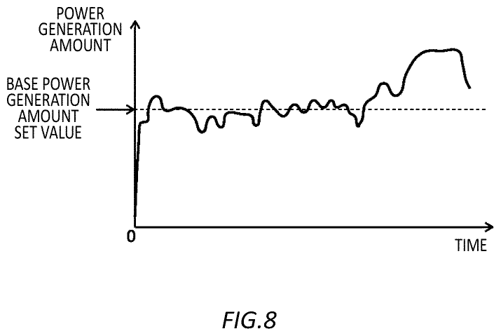

FIG. 8 illustrates the power generation amount of a fuel cell 270 when a base power generation amount set value is set to be relatively high. As illustrated in FIG. 8, by setting the base power generation amount set value to be relatively high, the base power generation amount set value becomes less likely lack with respect to the output request value to the power source 274, which enables the output power of the battery 272 to be suppressed when the output request value to the power source 274 is large. On the other hand, when the output request value to the power source 274 is small, since the charge amount to the battery 272 is increased, the SOC of the battery may be increased. In this case, since the power generation compensation amount for bringing the SOC of the battery closer to the target SOC increases in a negative direction, temporal change in the power generation amount of the fuel cell may vary by some degree according to the variation in the output request value. Therefore, the base power generation amount set value is desirably set to a value that is close to a temporal average of the output power requested to the power source 274.

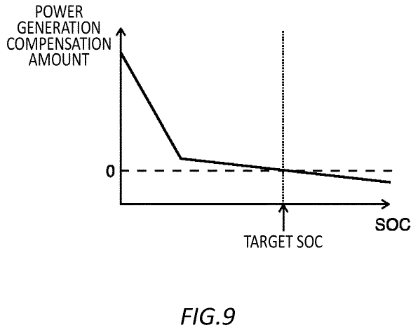

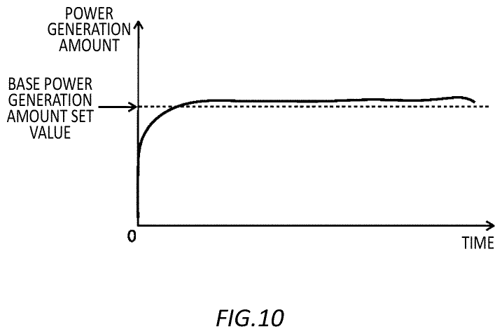

FIG. 9 is an example of a graph that represents the SOC-power generation compensation amount table 430 as a function of SOC. The horizontal axis in FIG. 9 represents the SOC, and the vertical axis represents the power generation compensation amount for the power generation amount set value. FIG. 10 is an example of the power generation amount of a fuel cell 270 when SOC-power generation compensation amount table 430 illustrated in FIG. 9 is used.

The target SOC in FIG. 9 is the same as the target SOC in FIG. 6. On the other hand, the overall gradient of the graph in FIG. 9 is smaller compared to the overall gradient of the graph in FIG. 6 as a whole. For example, in the predetermined SOC range including the target SOC, the absolute value of the gradient of the graph illustrated in FIG. 9 is smaller compared to the absolute value of the gradient of the graph illustrated in FIG. 6. Therefore, according to the SOC-power generation compensation amount table 430 illustrated in FIG. 9, the time responsiveness of bringing the SOC of the battery 272 closer to the target SOC becomes lower compared to the SOC-power generation compensation amount table 430 illustrated in FIG. 6.

As illustrated in FIG. 10, when the time responsiveness of bringing the SOC of the battery 272 to be closer to the target SOC is set to be relatively low by reducing the power generation compensation amount of the fuel cell 270 according to the SOC-power generation compensation amount table 430, the temporal change in the power generation amount of the fuel cell 270 can be suppressed. By reducing the power generation compensation amount of the fuel cell, the SOC of the battery 272 varies to some degree, but the lack or excess of SOC with respect to the target SOC can be temporally and gradually eliminated by small power generation compensation amount. In this manner, as illustrated in FIG. 10, the temporal change in the power generation amount of the fuel cell 270 can be suppressed. Thus, degradation of the fuel cell 270 becomes less likely to advance. In addition, the fuel economy of the fuel cell 270 may also improve.

As described in connection to FIG. 10 and the like, the temporal change in the power generation amount of the fuel cell 270 can be suppressed by reducing the power generation compensation amount of the fuel cell according to the SOC-power generation compensation amount table 430. In addition, as described in connection to FIG. 8 and the like, the temporal change in the power generation amount of the fuel cell 270 can be suppressed by setting the base power generation amount set value to be a value that is close to the temporal average of the output power requested to the power source 274. Thus, degradation of the fuel cell 270 can be suppressed.

In the present embodiment, the system 180 classifies traveling modes of the system 180 into a plurality of groups according to travel histories of the moving bodies 10, calculates a power generation compensation amount of the fuel cell 270 and a base power generation amount set value of the fuel cell 270 from the driving histories of the moving bodies 10 that belong to each group, and sets the calculated power generation compensation amount and base power generation amount set value as the control parameter for each group. In this manner, it is made possible to set appropriate power generation compensation amount and base power generation amount set value by using driving histories of moving bodies 10 with relatively similar travel modes.

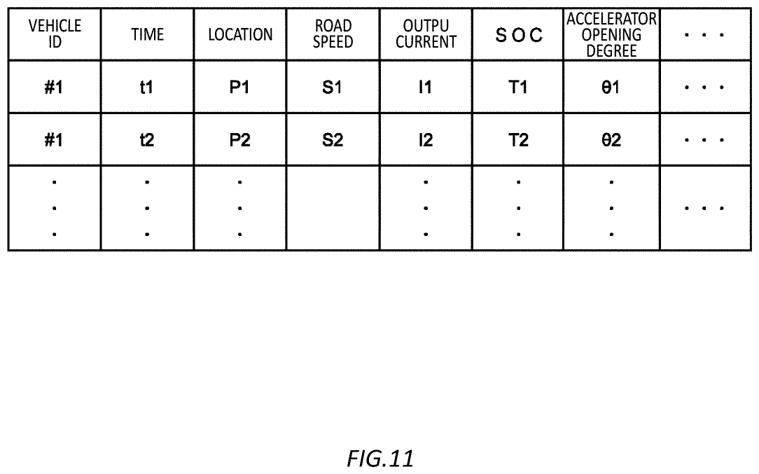

FIG. 11 illustrates a data structure of information indicating a driving history of a moving body 10, which is stored in a storage unit 390 of the system 180. The information indicating the driving history may be information that associates a vehicle ID which identifies a vehicle, the time, the location of the moving body 10, road speed of the moving body 10, output current of the fuel cell 270, SOC of the battery 272, and the accelerator opening degree with each other. The information indicating the driving history is transmitted from the moving body 10, received by the communication unit 380, acquired by the acquisition unit 310, and stored in the storage unit 390.

The grouping unit 330 sets a plurality of groups based on information indicating driving histories of the moving bodies 10. The group includes (i) a group of those that mainly travel on a highway, (ii) a group of those that mainly travel on an ordinary road, (iii) a group of those that mainly travel on an uphill road, (iv) a group of those that mainly travel on a downhill road, and the like. Each group may be defined as being composed of at least the same vehicle type. Therefore, different vehicle types will belong to different groups.

The group of those that mainly travel on a highway may be defined, for example, as a group to which moving bodies 10 with a ratio of travel distance on a highway to the total travel distance or a ratio of travel time on a highway to the total travel time that is higher than a predetermined value belong. Similarly, the group of those that mainly travel on an ordinary road may be defined, for example, as a group to which moving bodies 10 with a ratio of travel distance on an ordinary road to the total travel distance or a ratio of travel time on an ordinary road to the total travel time that is higher than a predetermined value belong. Similarly, the group of those that mainly travel on an uphill road may be defined, for example, as a group to which moving bodies 10 with a ratio of travel distance on an uphill road to the total travel distance or a ratio of travel time on an uphill road to the total travel time that is higher than a predetermined value belong. Similarly, the group of those that mainly travel on a downhill road may be defined, for example, as a group to which moving bodies 10 with a ratio of travel distance on a downhill road to the total travel distance or a ratio of travel time on a downhill road to the total travel time that is higher than a predetermined value belong.

The setting unit 340 sets, for each group, the power generation compensation amount and the base power generation amount set value of the fuel cell 270, as a control parameter of the fuel cell 270 corresponding to each group. The setting unit 340 sets, for the base power generation amount set value of a group of those that mainly travel on a highway, a value that is higher than the base power generation amount set value of a group of those that mainly travel on an ordinary road. When traveling on a highway, the road speed is higher than when traveling on an ordinary road, which increases the travel resistance, thereby the average value of output power from the power source 274 is increased. Therefore, by setting a relatively high value for the base power generation amount set value of the group of those that mainly travel on a highway, the amount of electrical power supplied from the battery 272 can be suppressed. In this manner, the SOC of the battery 272 can be prevented from falling largely below the target SOC while traveling on a highway. As a result, a situation in which the power generation amount of the fuel cell 270 is to be greatly increased to recover the SOC of the battery 272 to the target SOC can be prevented.

The setting unit 340 desirably sets, for the power generation compensation amount of the group of those that mainly travel on a highway, a value that is lower than the power generation compensation amount of the group of those that mainly travel on an ordinary road. When traveling on a highway, there are not many scenarios where significantly large acceleration is required. Therefore, when traveling on a highway, even if the SOC of the battery 272 is reduced, there is room for gradually recovering the SOC to the target SOC the power generation by taking a relatively long time after slightly increasing the power generation amount of the fuel cell 270. Therefore, by setting, for the power generation compensation amount of the group of those that mainly travel on a highway, a value that is lower than the power generation compensation amount of the group of those that mainly travel on an ordinary road, output variation of the fuel cell 270 can be suppressed. Thus, degradation of the fuel cell 270 can be suppressed.

Note that, when calculating the power generation compensation amount and the base power generation amount set value corresponding to the group of those that mainly travel on a highway, for example, the setting unit 340 may calculate the base power generation amount set value by considering the output current of the moving body 10 with a ratio of travel distance on a highway to the total travel distance or a ratio of travel time on a highway to the total travel time that is higher than a predetermined value. The setting unit 340 may calculate the power generation compensation amount and the base power generation amount set value at which the temporal change in the power generation amount of the fuel cell 270 becomes the smallest, by using the driving history of the moving body 10.

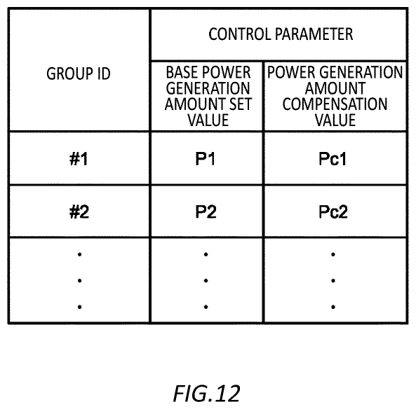

FIG. 12 illustrates a data structure of control parameter information for each group stored in the storage unit 390 of the system 180. The control parameter information includes a group ID, the base power generation amount set value, and the power generation amount compensation value. The group ID is identification information of the group. Each of the base power generation amount set value and the power generation amount compensation value is information calculated for each group by the setting unit 340. In the present embodiment, the target SOC may be defined to be fixed regardless of the group.

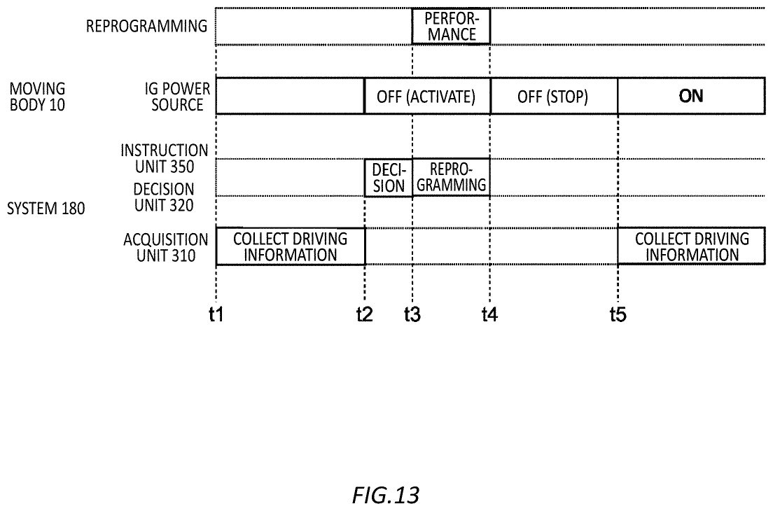

FIG. 13 illustrates a control sequence in a case where the control parameter of the fuel cell 270 is updated by reprogramming the control device 260. At time t1, when the ignition (IG) power source is turned on, the communication device 280 of the moving body 10 starts transmitting driving information to the system 180. In this manner, the acquisition unit 310 of the system 180 continually collects the driving information transmitted from the moving body 10.

When the IG power source is turned off at time t2, the communication device 280 informs the system 180 of the IG power source being turned off. The power state of the IG power source is turned to an off state, except for the part that operates for reprogramming of the control device 260.

In the system 180, the decision unit 320 decides the control parameter of the fuel cell 270 provided on the moving body 10 according to the group defined based on the driving history of the moving body 10. Once the control parameter is decided, the reprogramming of the control device 260 of the moving body 10 starts at time t3. Specifically, the instruction unit 350 transmits, to the moving body 10 through the communication unit 380, an update program to which the control parameter is reflected, as well as transmits an instruction indicating that the control program of the control device 260 is to be updated with the update program. Once the reprogramming is completed at time t4, the power state of the IG power source is completely turned to an off state.

Once the IG power source is turned to an on state at time t5, the communication device 280 of the moving body 10 starts transmitting driving information to the system 180. In this manner, the acquisition unit 310 of the system 180 continually collects the driving information transmitted from the moving body 10. At time t5 and further, the control device 260 controls the fuel cell 270 according to a new control parameter decided at the time of the IG power source being previously turned off.

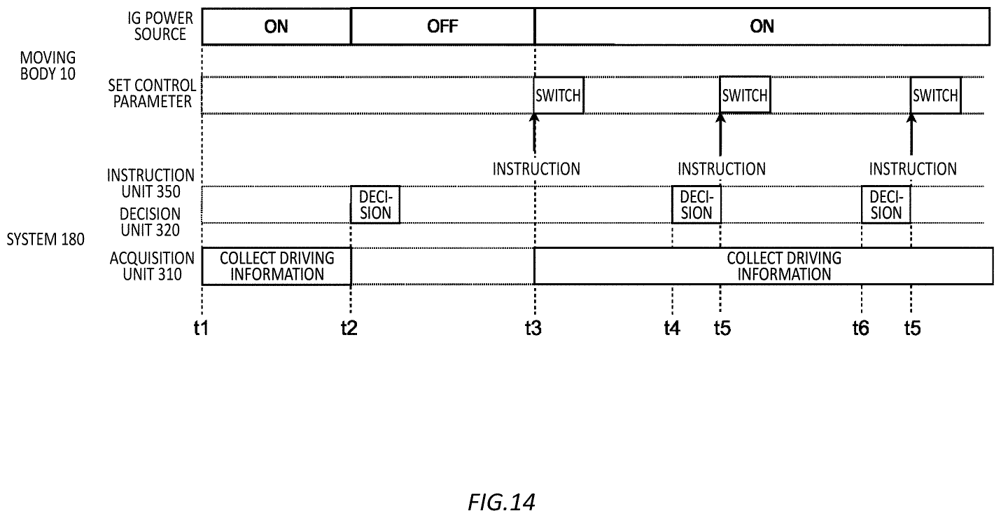

FIG. 14 illustrates a form in which the control parameter of the control device 260 is updated by providing the control device 260 with instructions on the control parameter. At time t1, when the IG power source is turned on, the communication device 280 of the moving body 10 starts transmitting driving information to the system 180. In this manner, the acquisition unit 310 of the system 180 continually collects the driving information transmitted from the moving body 10.

When the IG power source is turned off at time t2, the communication device 280 shows a control sequence in a case where the system 180 of the IG power source being turned off is notified. This control sequence is a valid control sequence when the control device 260 has received, from the system 180 in advance, and stored the plurality of control parameters.

In the system 180, the decision unit 320 decides the control parameter of the fuel cell 270 provided on the moving body 10 according to the group defined based on the driving history of the moving body 10. The identification information of the decided control parameter is stored in the storage unit 390 in association with the identification information of the moving body 10.

When the IG power source is turned on at time t3, the communication device 280 of the moving body 10 starts transmitting driving information to the system 180. When the system 180 detects that the IG power source of the moving body 10 is turned on, the instruction unit 350 transmits, to the moving body 10 through the communication unit 380, the identification information of the control parameter stored in the storage unit 390 in association with the identification information of the moving body 10, thereby instructing the control device 260 to control the fuel cell 270 with the control parameter identified by the identification information transmitted.

At time t4, the decision unit 320 newly decides a control parameter of the fuel cell 270 provided on the moving body 10, according to the group defined based on the driving history of the moving body 10. For example, the decision unit 320 may newly decide a control parameter of the moving body 10 in a situation where the control device 260 belongs to a group that is different from the group corresponding to the control program to be used for control of the fuel cell 270. For example, assume that it is decided at time t2 that the moving body 10 belongs to the group of those that mainly travel on a highway. Here, at time t4, the decision unit 320 decides the control parameter associated with the group of those that mainly travel on an ordinary road, as the control parameter of the fuel cell 270 of the moving body 10, when it is decided that the moving body 10 will only pass through an ordinary road without passing through a highway for a future predetermined time, based on the information indicating the current location of the moving body 10 and the scheduled traveling route of the moving body 10. The instruction unit 350 transmits, to the moving body 10 through the communication unit 380, the identification information of the control parameter decided by the decision unit 320, thereby instructing the control device 260 to control the fuel cell 270 with the control parameter identified by the transmitted identification information.

At time t5, the decision unit 320 newly decides a control parameter of the fuel cell 270 provided on the moving body 10, according to the group defined based on the driving history of the moving body 10. For example, the decision unit 320 may newly decide a control parameter of the moving body 10 in a situation where the control device 260 belongs to a group that is different from the group corresponding to the control program to be used for control of the fuel cell 270. For example, assume that it is decided at time t4 that the moving body 10 belongs to the group of those that mainly travel on an ordinary road. Here, at time t6, the decision unit 320 decides the control parameter associated with the group of those that mainly travel on an uphill road, as the control parameter of the fuel cell 270 of the moving body 10, when it is decided that the moving body 10 will mainly pass through an uphill road for a future predetermined time, based on the information indicating the scheduled traveling route of the moving body 10. The instruction unit 350 transmits, to the moving body 10 through the communication unit 380, the identification information of the control parameter decided by the decision unit 320, thereby instructing the control device 260 to control the fuel cell 270 with the control parameter identified by the transmitted identification information.

In this manner, the system 180 can temporarily change the control program by specifying the control parameter of the control device 260. By doing so, the control program can be temporarily changed when it is predicted that the travel mode of the moving body 10 is different from the travel mode that is predicted from normal driving histories.

In the present embodiment, the base power generation amount set value and the power generation amount compensation value were illustrated as examples of the control parameter, and the base power generation amount set value and the power generation amount compensation value were described to be set for each group. However, an embodiment in which the target SOC as an example of the control parameter of the battery 272 is set for each group can also be adopted. In the present embodiment, although an embodiment in which the system 180 has a functionality of deciding the control parameter of the fuel cell 270 has been described, an embodiment in which the moving body system 100 has the functionality of deciding the control parameter of the fuel cell 270 may be adopted.

In the control system 190 described above, the moving body 10 is assumed to be a vehicle. However, any moving body other than the vehicle may be applied as the moving body 10.

According to the control system 190 described above, the fuel cell 270 provided on the moving body 10 can be controlled with the control parameter set for the group estimated from the driving history of the moving body 10. In this manner, the fuel cell 270 can be controlled with an appropriate control parameter according to the travel mode of the moving body 10. Accordingly, it can be expected that the fuel economy of the fuel cell 270 will be improved, and degradation can be reduced.

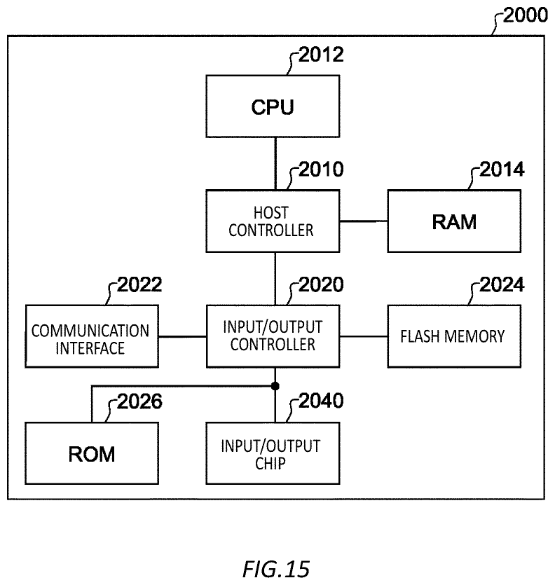

FIG. 15 illustrates an example of a computer 2000 in which a plurality of embodiments of the present invention can be entirely or partially embodied. A program installed in the computer 2000 can cause the computer 2000 to function as each unit of the system 180 or the moving body system 100, a device such as the system 180 or each unit of the device according to the embodiment to execute an operation associated with the system or each unit of the system, the device, or each unit of the device, and/or execute a process or a step of the process according to the embodiment. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

A program that is installed in the computer 2000 and causes the computer 2000 to function as the system 180 may work on the CPU 2012 and the like to cause the computer 2000 to function as each unit of the system 180, respectively. Information processing described in these programs are read into the computer 2000 to cause the computer to function as each unit of the system 180, which is a specific means realized by cooperation of software and the various types of hardware resources described above. Then, with these specific means, by realizing computing or processing of information according to an intended use of the computer 2000 in the present embodiment, a unique system 180 according to the intended use is constructed.

The program installed in the computer 2000 to cause the computer 2000 to function as the moving body system 100 may work on the CPU 2012 and the like to cause the computer 2000 to function as each unit of the moving body system 100, respectively. The information processing described in these programs is read by the computer 2000 to function as each unit of the moving body system 100 which is specific means by which a software and the above-described various hardware resources cooperate. Then, with these specific means, by realizing computing or processing of information according to an intended use of the computer 2000 in the present embodiment, a unique moving body system 100 according to the intended use is constructed.

While the present invention has been described by way of the embodiments, the technical scope of the present invention is not limited to the above described embodiments. It is apparent to persons skilled in the art that various alterations or improvements can be made to the above described embodiments. It is also apparent from description of the claims that the embodiments to which such alterations or improvements are made can be included in the technical scope of the present invention.

Each process of the operations, procedures, steps, and stages etc. in the apparatus, system, program, and method shown in the claims, specification, or diagrams can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: moving body,
100: moving body system,
180: system,
190: control system,
200: processing system,
210: acquisition unit,
220: decision unit,
230: reprogramming unit,
250: navigation system,
260: control device,
270: fuel cell,
272: battery,
274: power source,
278: motor,
280: communication device,
300: processing unit,
310: acquisition unit,
320: decision unit,
330: grouping unit,
340: setting unit,
350: instruction unit,
380: communication unit,
390: storage unit,
400: output request value-power generation amount set value table,
420: adder,
430: SOC-power generation compensation amount table,
2000: computer,
2010: host controller,
2012: CPU,
2014: RAM
2020: input/output controller,
2022: communication interface,
2024: flash memory,
2026: ROM,
2040: input/output chip.

What is claimed is:

1. A system for controlling a power source including a fuel cell and a battery provided on a vehicle, the system comprising:
a decision unit that decides a control parameter for power generation amount of the fuel cell based on whether the vehicle is a vehicle that mainly travels on a highway or a vehicle that mainly travels on an ordinary road.

2. The system according to claim 1, further comprising an acquisition unit that acquires information indicating a driving history of the vehicle,
wherein the decision unit decides whether the vehicle is a vehicle that mainly travels on a highway or a vehicle that mainly travels on an ordinary road based on the driving history.

3. The system according to claim 1, wherein
the control parameter for power generation amount includes a set value which is defined from an output request for the power source and which becomes constant with respect to the output request at least within a predetermined range.

4. The system according to claim 3, wherein
the control parameter for power generation amount includes a compensation amount for compensating a power generation amount of the fuel cell with respect to the set value to bring a charge percentage of the battery closer to a predetermined target value.

5. The system according to claim 4, wherein
the decision unit reduces the compensation amount when it is decided that the vehicle is a vehicle that mainly travels on a highway as compared to when it is decided that the vehicle is a vehicle that mainly travels on an ordinary road.

6. The system according to claim 3, wherein
the decision unit increases the set value when it is decided that the vehicle is a vehicle that mainly travels on a highway as compared to when it is decided that the vehicle is a vehicle that mainly travels on an ordinary road.

7. The system according to claim 4, wherein
the decision unit reduces the compensation amount and increases the set value when it is decided that the vehicle is a vehicle that mainly travels on a highway as compared to when it is decided that the vehicle is a vehicle that mainly travels on an ordinary road.

8. The system according to claim 3, wherein
the decision unit reduces the set value when it is decided that the vehicle is a vehicle that mainly travels on an ordinary road as compared to when it is decided that the vehicle is a vehicle that mainly travels on a highway.

9. The system according to claim 4, wherein
the decision unit increases the compensation amount when it is decided that the vehicle is a vehicle that mainly travels on an ordinary road as compared to when it is decided that the vehicle is a vehicle that mainly travels on a highway.

10. The system according to claim 4, wherein
the decision unit reduces the set value and increases the compensation amount when it is decided that the vehicle is a vehicle that mainly travels on an ordinary road as compared to when it is decided that the vehicle is a vehicle that mainly travels on a highway.

11. The system according to claim 2, wherein
the acquisition unit acquires information indicating driving histories of a plurality of vehicles,
the system further comprising:
a grouping unit that generates a plurality of groups according to traveling modes of the plurality of vehicles, based on the information indicating the driving histories of the plurality of vehicles; and
a setting unit that sets, for each of the plurality of groups, the control parameter for vehicles that belong to each group, based on information indicating the driving histories of the plurality of vehicles, wherein
the decision unit decides which group among the plurality of groups the traveling mode of the vehicle belongs to, based on a driving history of the vehicle, and decides that a control parameter set for the group decided is to be set as the control parameter for the fuel cell included in the power source of the vehicle.

12. The system according to claim 11, further comprising:
an instruction unit that instructs the vehicle to reprogram a control device of the power source provided on the vehicle such that the fuel cell is controlled based on the control parameter decided by the decision unit.

13. The system according to claim 11, wherein the vehicle stores a plurality of the control parameters set for the plurality of groups,
the system further comprising:
an instruction unit that instructs the vehicle to control the fuel cell based on the control parameters decided by the decision unit.

14. The system according to claim 1, wherein
the decision unit decides the control parameter further based on at least one of a scheduled traveling route of the vehicle and a current location of the vehicle.

15. The system according to claim 2, wherein
the control parameter for power generation amount includes a set value which is defined from an output request for the power source and which becomes constant with respect to the output request at least within a predetermined range.

16. The system according to claim 15, wherein
the control parameter for power generation amount includes a compensation amount for compensating a power generation amount of the fuel cell with respect to the set value to bring a charge percentage of the battery closer to a predetermined target value.

17. The system according to claim 16, wherein
the decision unit reduces the compensation amount when it is decided that the vehicle is a vehicle that mainly travels on a highway as compared to when it is decided that the vehicle is a vehicle that mainly travels on an ordinary road.

18. The system according to claim 15, wherein
the decision unit increases the set value when it is decided that the vehicle is a vehicle that mainly travels on a highway as compared to when it is decided that the vehicle is a vehicle that mainly travels on an ordinary road.

19. A control method for controlling a power source including a fuel cell and a battery provided on a vehicle, the control method comprising:
deciding a control parameter for power generation amount of the fuel cell based on whether the vehicle is a vehicle that mainly travels on a highway or a vehicle that mainly travels on an ordinary road.

20. A non-transitory computer readable storage medium having stored thereon a program, wherein in order to control a power source including a fuel cell and a battery provided on a vehicle, the program causes a computer to decide a control parameter for power generation amount of the fuel cell based on whether the vehicle is a vehicle that mainly travels on a highway or a vehicle that mainly travels on an ordinary road.
